(19) United States
(12) Patent Application Publication
(10) Pub. No.: US 2025/0142376 A1
(43) Pub. Date: May 1, 2025

(54) METHOD AND DEVICE FOR MONITORING AUTOMATIC FREQUENCY ADJUSTMENT SYSTEM

(71) Applicant: ELECTRONICS AND TELECOMMUNICATIONS RESEARCH INSTITUTE, Daejeon (KR)

(72) Inventors: Seung Keun PARK, Daejeon (KR); Sung Jun LEE, Daejeon (KR); Bong Soo KIM, Daejeon (KR); Jae Ho JUNG, Daejeon (KR); Byung Su KANG, Daejeon (KR); Hye Yeon KWON, Daejeon (KR); Igor KIM, Daejeon (KR); Kwang Chun LEE, Daejeon (KR)

(73) Assignee: ELECTRONICS AND TELECOMMUNICATIONS RESEARCH INSTITUTE, Daejeon (KR)

(21) Appl. No.: 18/927,071

(22) Filed: Oct. 25, 2024

(30) Foreign Application Priority Data
Oct. 25, 2023 (KR) 10-2023-0143735

(51) Int. Cl. H04W 24/08; H04W 48/10; H04W 52/36; H04W 84/12; H04W 88/08

(52) U.S. Cl. CPC H04W 24/08; H04W 48/10; H04W 52/367; H04W 84/12; H04W 88/08

(57) ABSTRACT

A wireless system including a wireless station and an automatic frequency adjustment system and a method for controlling the same are disclosed. According to one embodiment of the present disclosure, the wireless system may include a wireless station including a beacon demodulator and an automatic frequency adjustment system having a database including identification information of a plurality of wireless local area network (LAN) access points (Aps), and the wireless station may be configured to: obtain information related to a first beacon frame by demodulating the first beacon frame transmitted from a first wireless LAN AP through the beacon demodulator and transmit the information related to the first beacon frame to the automatic frequency adjustment system.

### CROSS-REFERENCE TO RELATED APPLICATIONS

This application claims the benefit of earlier filing date and right of priority to Korean Application No. 10-2023-0143735, filed on Oct. 25, 2023, the contents of which are all hereby incorporated by reference herein in their entirety.

### TECHNICAL FIELD

The present disclosure relates to a method for monitoring an automatic frequency adjustment system, and more particularly, to a method and device for monitoring an automatic frequency adjustment system for a wireless LAN to use a frequency while protecting an existing wireless (or radio) station in a frequency sharing environment where an existing wireless station exists.

### BACKGROUND

Recently, a method of jointly using some frequencies in the 6 GHz band (i.e., 5.925 GHz to 7.125 GHz band) has been introduced as a method of utilizing wireless LAN frequencies. Specifically, the above method is a method of jointly using some frequencies by applying a geo-location method from the perspective of secondary frequency users while protecting existing wireless stations, which are primary frequency users.

The U.S. Wi-Fi (Wireless Fidelity) Alliance and others have developed an AFC (Automated Frequency Coordination) system that uses a geo-location-based frequency sharing method by using the receiving device information of existing wireless stations, such as the receiving antenna location of existing wireless stations, the receiving antenna pattern of existing wireless stations, and the frequency of use, as well as the location information of wireless LAN APs (Access Points), in accordance with the frequency sharing technology standards of the U.S. Federal Communications Commission (FCC).

In the case of a conventional AFC system (hereinafter referred to as an automatic frequency adjustment system), when a request for information to jointly use the frequency of an existing wireless station is received from a wireless LAN AP registered by accessing the system, information on the available channel number and maximum allowable channel power or maximum allowable power per MHz can be provided to the wireless LAN AP.

The above-described method cannot completely protect existing wireless stations from interference signals of wireless LAN due to the diversity of indoor and outdoor transmission losses, uncertainty of propagation path loss, and random characteristics of terrain clutter.

That is, in the case of a conventional automatic frequency adjustment system, when a wireless LAN AP is connected to the system and, upon request of a registered wireless LAN AP, information on the available channel number and maximum allowable channel power or maximum allowable power per MHz is provided to the wireless LAN AP, the wireless LAN AP can determine the channel number and power, etc. based on the information and then transmit a wireless LAN AP signal.

In this situation, when radio interference occurs in existing wireless stations in the vicinity due to the wireless LAN AP, there is a problem in that the conventional method cannot detect and identify the specific wireless LAN AP causing radio interference to the existing wireless station.

### SUMMARY

The purpose of the present disclosure is to provide a method and device for monitoring an automatic frequency adjustment system.

The purpose of the present disclosure is to provide a method and device for protecting existing wireless stations in a frequency band to which an automatic frequency adjustment system is applied in a radio wave environment where a wireless LAN AP shares frequencies with existing wireless stations.

The purpose of the present disclosure is to provide a method for monitoring interference with the channel number and channel transmission power of a wireless LAN AP.

The purpose of the present disclosure is to provide a method for obtaining domestic terrain-based propagation path loss data by directly measuring the transmission power and reception power of a beacon for each wireless LAN AP.

The purpose of the present disclosure is to provide a method for stopping transmission operation of a wireless LAN AP located close to an existing wireless station based on reception quality deterioration information obtained through a reception quality measurement device of the existing wireless station when the existing wireless station receives interference from a surrounding wireless LAN AP.

The technical problems to be achieved in the present disclosure are not limited to the technical tasks mentioned above, and other technical problems not mentioned will be clearly understood by those skilled in the art from the description below.

According to one embodiment of the present disclosure, a wireless system may include a wireless station including a beacon demodulator; and an automatic frequency adjustment system having a database including identification information of a plurality of wireless local area network (LAN) access points (Aps), and the wireless station may be configured to: obtain information related to a first beacon frame by demodulating the first beacon frame transmitted from a first wireless LAN AP through the beacon demodulator; and transmit the information related to the first beacon frame to the automatic frequency adjustment system, and the automatic frequency adjustment system may be configured to: identify a first wireless LAN AP that matches the information related to the first beacon frame among the plurality of wireless LAN APs through the database; and transmit a new channel and maximum allowable power to be used by the first wireless LAN AP to the first wireless LAN AP based on the information related to the first beacon frame.

In addition, the information related to the first beacon frame may include a number of a wireless LAN channel through which the first beacon frame was transmitted, a bandwidth of the wireless LAN channel, a reception power of the first beacon frame, and identification information of the first wireless LAN AP that transmitted the first beacon frame.

In addition, the identification information of the first wireless LAN AP may include at least one of an authentication ID, a serial number, a basic service set (BSS) ID, or a medium access control (MAC) address of the first wireless LAN AP.

In addition, the wireless station may include at least one of a beacon power measurement device or a reception quality measurement device, a power of a target signal received from a transmitting device may be measured by the reception quality measurement device, and the reception power of the first beacon frame, which is an interference signal of the target signal, may be measured by the beacon power measurement device.

In addition, a first frequency band in which the first beacon frame may be transmitted is adjacent to a second frequency band in which the target signal is transmitted, and the automatic frequency adjustment system may be configured to: identify at least one wireless LAN AP within a predefined distance from the first wireless LAN AP that transmitted the first beacon frame based on the database, and identify a second wireless LAN AP that transmits a second beacon frame in the second frequency band among the at least one wireless LAN AP.

In addition, the automatic frequency adjustment system may be configured to: transmit, to the second wireless LAN AP, at least one of a first message including a new channel and maximum allowable power to be used by the second wireless LAN AP or a second message indicating a stop of use of the second frequency band.

In addition, the beacon demodulator may identify a reception power of the first beacon frame through a transmitter power control (TPC) report element included in the first beacon frame, and the automatic frequency adjustment system may set a maximum allowable power of the first beacon frame to a value equal to a predefined ratio of a noise power of the wireless system.

In addition, the reception quality measurement device may monitor a reception quality of the target signal based on at least one of a signal-to-noise ratio (SNR) or bit error rate (BER) of the target signal.

In addition, the automatic frequency adjustment system may be configured to: receive information on the reception quality of the target signal from the wireless station, and based on the reception quality of the target signal not satisfying a specific criterion, transmit a third message to the first wireless LAN AP requesting to stop transmitting the first beacon frame.

According to another embodiment of the present disclosure, a method for controlling a wireless system including a wireless station and an automatic frequency adjustment system may include obtaining information related to a first beacon frame by demodulating a first beacon frame transmitted from a first wireless LAN AP by the wireless station; transmitting the information related to the first beacon frame by the wireless station to the automatic frequency adjustment system; identifying the first wireless LAN AP that matches the information related to the first beacon frame among a plurality of wireless LAN APs through a database including identification information of the plurality of wireless LAN APs by the automatic frequency adjustment system; and transmitting, to the first wireless LAN AP, a new channel and maximum allowable power to be used by the first wireless LAN AP based on the information related to the first beacon frame by the automatic frequency adjustment system.

In addition, the method may include identifying, by the automatic frequency adjustment system, at least one wireless LAN AP within a predefined distance from the first wireless LAN AP that transmitted the first beacon frame based on the database, and identifying, by the automatic frequency adjustment system, a second wireless LAN AP that transmits a second beacon frame in the second frequency band among the at least one wireless LAN AP.

In addition, the method may include transmitting, by the automatic frequency adjustment system, to the second wireless LAN AP at least one of a first message including a new channel and maximum allowable power to be used by the second wireless LAN AP or a second message indicating a stop of use of the second frequency band.

In addition, the obtaining information related to the first beacon frame may include by the wireless station, identifying a reception power of the first beacon frame through a transmitter power control (TPC) report element included in the first beacon frame, and the transmitting a maximum allowable power to be used by the first wireless LAN AP may include: setting a maximum allowable power of the first beacon frame to a value equal to a predefined ratio of a noise power of the wireless system.

In addition, the method may include by the automatic frequency adjustment system, receiving information on the reception quality of the target signal from the wireless station, and by the automatic frequency adjustment system, based on the reception quality of the target signal not satisfying a specific criterion, transmitting a third message to the first wireless LAN AP requesting to stop transmitting the first beacon frame.

According to one embodiment of the present disclosure, an automatic frequency adjustment system may include at least one memory; at least one transceiver; and at least one processor, and the at least one processor may be configured to: receive, from a wireless station through the at least one transceiver, information related to a first beacon frame transmitted from a first wireless LAN AP; identify the first wireless LAN AP matching the information related to the first beacon frame among a plurality of wireless LAN APs through a database including identification information of the plurality of wireless LAN Aps; and transmit, to the first wireless LAN AP through the at least one transceiver, a new channel and maximum allowable power to be used by the first wireless LAN AP based on the information related to the first beacon frame.

According to one embodiment of the present disclosure, a frequency monitoring method performed by an automatic frequency adjustment system may include receiving, from a wireless station, information related to a first beacon frame transmitted from a first wireless LAN AP; identifying the first wireless LAN AP matching the information related to the first beacon frame among a plurality of wireless LAN APs through a database including identification information of the plurality of wireless LAN Aps; and transmitting, to the first wireless LAN AP, a new channel and maximum allowable power to be used by the first wireless LAN AP based on the information related to the first beacon frame.

The features briefly summarized above with respect to the disclosure are merely exemplary aspects of the detailed description of the disclosure that follows, and do not limit the scope of the disclosure.

According to various embodiments of the present disclosure, a method and device for monitoring an automatic frequency adjustment system may be provided.

According to various embodiments of the present disclosure, a method and device for protecting an existing wireless station in a frequency band to which an automatic frequency adjustment system is applied may be provided in a radio wave usage environment where a wireless LAN AP jointly uses a frequency with an existing wireless station.

According to various embodiments of the present disclosure, a method for monitoring interference with a channel number and channel transmission power of a wireless LAN AP may be provided.

According various embodiments of the present disclosure, a method for obtaining domestic terrain-based propagation path loss data by directly measuring transmission power and reception power of a beacon for each wireless LAN AP may be provided.

According to various embodiments of the present disclosure, when an existing wireless station receives interference from a surrounding wireless LAN AP, a method of stopping transmission operation of a wireless LAN AP located close to the existing wireless station may be provided based on reception quality deterioration information acquired through a reception quality measurement device of the existing wireless station.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings included as part of the detailed description to facilitate understanding of the present disclosure provide embodiments of the present disclosure and describe technical features of the present disclosure along with detailed descriptions.

FIG. 1 is a flowchart for explaining a monitoring method of an automatic frequency adjustment system performed by a device according to one embodiment of the present disclosure.

FIG. 2 illustrates a channel bandwidth distinguished in a wireless LAN system.

FIG. 3 is a flowchart for explaining a monitoring method of an automatic frequency adjustment system according to one embodiment of the present disclosure.

FIG. 4 to FIG. 6 are diagrams for explaining a configuration of an automatic frequency adjustment system according to one embodiment of the present disclosure.

FIG. 7 is a diagram for explaining a method for measuring a beacon of a surrounding wireless LAN AP in an adjacent frequency band according to one embodiment of the present disclosure.

FIG. 8 is a diagram for explaining a method using a beacon of a wireless LAN AP according to one embodiment of the present disclosure.

FIG. 9 is a diagram for explaining a device and method using a reception quality measurement device of an existing wireless station according to one embodiment of the present disclosure.

FIG. 10 is a block diagram illustrating one or more devices constituting an automatic frequency adjustment system according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The system and/or method/device (hereinafter simply referred to as the ‘system’) proposed in the present disclosure relates to a monitoring technology of an automatic frequency regulation system.

The present disclosure may be used in a radio frequency environment where a wireless LAN AP shares a frequency with an existing wireless station. In particular, the present disclosure may be applied in a frequency band to which an automatic frequency adjustment system is applied among the 5.925 GHz band and the 7.125 GHz band.

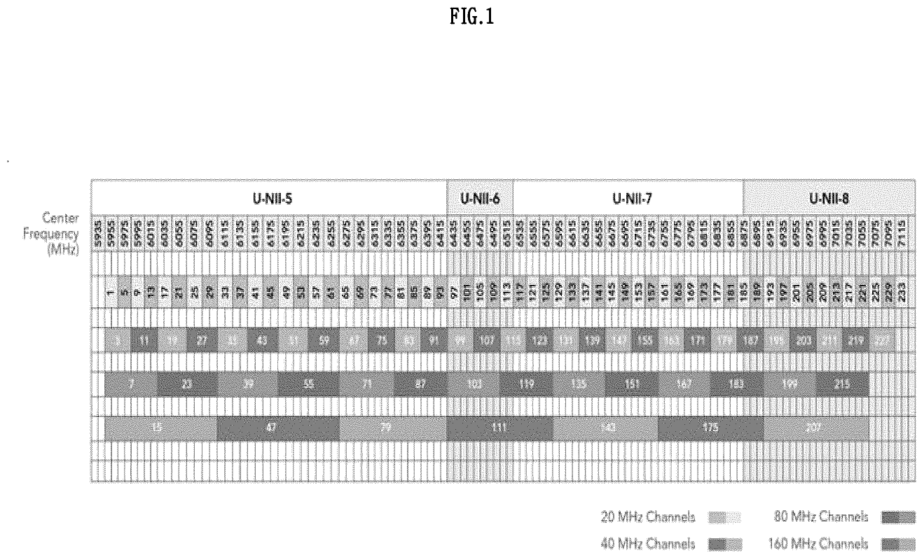

FIG. 1 shows the channel numbers and channel bandwidths that can be used by Wi-Fi 6E wireless LAN APs in the 5.925 GHz band to the 7.125 GHz band used by existing wireless stations.

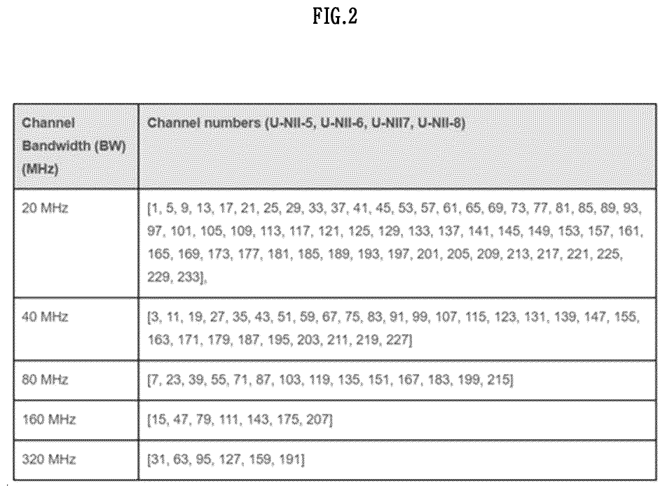

FIG. 2 shows that the channel bandwidth used by an AP that complies with a wireless LAN standard using a 6 GHz frequency, such as a Wi-Fi 6E, IEEE 802.11be-based wireless LAN system (or, Wi-Fi 7), can be distinguished according to the channel number. When the IEEE 802.11be standard specification is completed, a channel number with a width of 320 MHz may be newly added in FIG. 2.

The frequency range to which the automatic frequency adjustment system is applied in the channel environment of the 6 GHz band wireless LAN as above varies depending on the frequency usage environment of each country. In the United States, the automatic frequency adjustment system is applied to the 5.925 to 6.425 GHz band and the 6.525 to 6.875 GHz band, and in Canada, the automatic frequency adjustment system is applied to the 5.925 GHz band to the 6.875 GHz band.

In the case of a method related to a basic automatic frequency adjustment system, the system provides frequency joint use information according to the requirements of a wireless LAN AP registered by connecting to the automatic frequency adjustment system.

Here, the requirements of the wireless LAN AP may include information for frequency co-use with an existing wireless station in some or all of the co-use frequencies among the applicable bands of the automatic frequency adjustment (or coordination) system (e.g., the channel number of the available wireless LAN, the maximum allowable channel power, or the maximum allowable power per MHz, etc.).

That is, a wireless LAN AP that has been previously connected to and registered in an automatic frequency adjustment system may request frequency sharing information from the automatic frequency adjustment system. Afterwards, the wireless LAN AP may determine a channel number and channel power or power per MHz based on the frequency sharing information requested and obtained, and then transmit a signal.

However, the basic automatic frequency adjustment system has a problem in that it does not monitor the wireless environment at all in which the transmitted wireless LAN AP signal may cause radio interference to nearby fixed wireless stations.

Therefore, in order to improve the problems of the above-described basic automatic frequency adjustment method, the present disclosure uses a method of using the BSS (Basic Service Set) ID of a wireless LAN AP from a beacon periodically transmitted from a wireless LAN AP operating around a fixed wireless station or the identification information of a wireless LAN AP pre-registered in an automatic frequency adjustment system.

That is, the present disclosure relates to a new monitoring method and device that protects an existing wireless station better than before by obtaining information such as a channel number, channel bandwidth, and reception power of a wireless LAN AP currently in use and then applying the information to an automatic frequency adjustment system.

In addition, the present disclosure relates to a method for determining/monitoring whether to suspend or continue operation of a wireless LAN AP existing around an existing wireless station based on reception quality information obtained through a reception quality measurement device when the existing wireless station has a reception quality measurement device.

Additionally, there is a problem that the information on available channel number and maximum allowable channel power or maximum allowable power per MHz provided by a basic automatic frequency adjustment system is heavily dependent on a propagation path loss model between an existing wireless station and a wireless LAN AP (e.g., WINNER (Wireless World Initiative New Radio) II model, ITM (Irregular Terrain Model) propagation model adopted by the U.S. FCC, propagation model on ITU (International Telecommunications Union) P.452, etc.).

That is, since the basic automatic frequency adjustment system relies on a statistical propagation path loss model developed through representative sampling, there is a problem that there is always a possibility of providing information calculated based on an incorrect propagation path loss value to the wireless LAN AP.

The present disclosure describes a method for detecting and identifying a wireless LAN AP that interferes with an existing wireless station by combining a method of sensing a beacon signal of a wireless LAN AP with a geo-location method, and a new monitoring method and device that individually provides information such as a newly updated available channel number and maximum allowable channel power or maximum allowable power per MHz to the wireless LAN AP that causes the interference.

In addition, the present disclosure describes a method and device capable of stopping transmission operation of a surrounding wireless LAN AP when performance degradation of an existing wireless station due to an AP signal of a wireless LAN is detected through monitoring based on a reception quality measurement device of the existing wireless station.

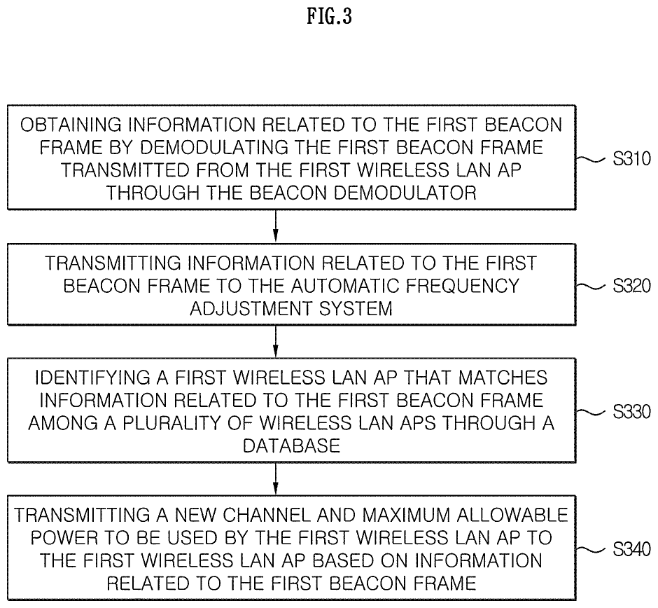

FIG. 3 is a flowchart for explaining a monitoring method of an automatic frequency adjustment system according to one embodiment of the present disclosure.

The present disclosure may include a method of using a beacon of a wireless LAN AP in an automatic frequency adjustment system and a method of using a reception quality measurement device of an existing wireless station.

The wireless station may obtain information related to the first beacon frame by demodulating the first beacon frame transmitted from the first wireless LAN AP through the beacon demodulator (S310).

Here, information related to the first beacon frame may include the number of the wireless LAN channel through which the first beacon frame was transmitted, the bandwidth of the wireless LAN channel, the reception power of the first beacon frame, and identification information of the first wireless LAN AP that transmitted the first beacon frame.

And, the identification information of the first wireless LAN AP may include at least one of an authentication ID, a serial number, a BSS (basic service set) ID, or a MAC (medium access control) address of the first wireless LAN AP.

As an example of the present disclosure, the wireless station may include at least one of a beacon power measurement device or a reception quality measurement device.

For example, the wireless station may measure the reception power of the first beacon frame, which is an interference signal, through a beacon power measurement device. In addition, the wireless station may measure at least one of a signal-to-noise ratio (SNR) or a bit error rate (BER) of a target signal (i.e., a signal desired by the wireless station) through a reception quality measurement device. Accordingly, the reception quality measurement device may monitor the reception quality of the target signal.

Here, the first frequency band in which the first beacon frame is transmitted may be adjacent to the second frequency band in which the target signal is transmitted.

The wireless station may transmit information related to the first beacon frame to the automatic frequency adjustment system (S320).

The automatic frequency adjustment system may identify a first wireless LAN AP that matches information related to the first beacon frame among a plurality of wireless LAN APs through a database (S330).

Specifically, the automatic frequency adjustment system may store a database including information related to a plurality of wireless LAN APs. The database may include identification information for identifying a plurality of wireless LAN APs, information related to beacon frames transmitted by the plurality of wireless LAN APs, and the like.

The automatic frequency adjustment system may identify the first wireless LAN AP through identification information of the first wireless LAN AP that transmitted the first beacon frame among information related to the first beacon frame.

The automatic frequency adjustment system may transmit a new channel and maximum allowable power to be used by the first wireless LAN AP to the first wireless LAN AP based on information related to the first beacon frame (S340).

That is, the automatic frequency adjustment system can instruct the first wireless LAN AP on a new channel to be used for transmitting beacon frames, etc. Additionally or alternatively, the automatic frequency adjustment system can transmit information indicating the maximum allowable power of the first wireless LAN AP to the first wireless LAN AP.

For example, the beacon demodulator may identify the received power of the first beacon frame through a transmitter power control (TPC) report element included in the first beacon frame. The automatic frequency adjustment system may set the maximum allowable power of the first beacon frame to a value equal to a predefined percentage of the noise power of the wireless system (e.g., a system associated with the wireless station).

Additionally, the automatic frequency adjustment system may identify one or more wireless LAN APs (i.e., one or more wireless LAN APs within a specific radius centered on the first wireless LAN AP) that are within a predefined distance from the first wireless LAN AP that transmitted the first beacon frame based on the database.

The automatic frequency adjustment system may identify a second wireless LAN AP transmitting a second beacon frame in a second frequency band among one or more wireless LAN APs. The automatic frequency adjustment system may transmit at least one of a first message including a new channel and maximum allowable power to be used by the second wireless LAN AP or a second message indicating to stop using the second frequency band to the second wireless LAN AP.

Additionally, the automatic frequency adjustment system may receive information about the reception quality of the target signal from the wireless station. Based on the reception quality of the target signal not meeting a certain criterion, the automatic frequency adjustment system may transmit a third message to the first wireless LAN AP requesting that it stop transmitting the first beacon frame.

The requirements that a wireless LAN AP requests from an automatic frequency adjustment system in order to share a frequency with an existing wireless station can be divided into a per-channel basis and a per-MHz basis. Hereinafter, the requirements related to the per-channel basis will be explained first.

The monitoring method of the present disclosure using a beacon of a wireless LAN AP can be divided into two cases: i) a case of measuring a beacon of an unwanted wireless LAN AP in a surrounding while an existing wireless station has stopped transmitting a desired signal for a certain period of time, and ii) a case of measuring a beacon of a surrounding wireless LAN AP received in an adjacent frequency band not occupied by a desired signal while an existing wireless station continues transmitting a desired signal.

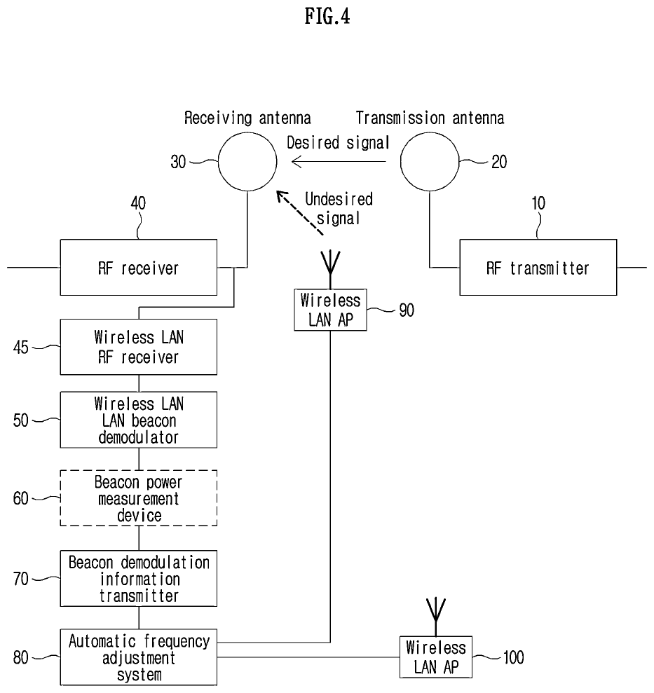

FIG. 4 illustrates a case where a beacon of an unwanted wireless LAN AP in the vicinity is measured in a situation where an existing wireless station has stopped transmitting a desired signal for a certain period of time.

For example, when interference occurs during a receiving procedure, a fixed wireless station may easily measure the interference signal in the case where it is not transmitting the desired signal.

Additionally or alternatively, a monitoring time may be configured to detect the presence of ambient interference signals during specific times when the fixed wireless station is not communicating.

Referring to FIG. 4, an existing wireless station may transmit a desired signal through an RF transmitter (10) and a transmitting antenna (20), but the existing wireless station may not transmit the signal. In this case, the receiving antenna (30) and RF receiver (40) of the existing wireless station may receive undesired (or unwanted) signals in the surroundings and beacons of wireless LAN APs.

That is, as an example of the present disclosure, in order to detect/identify undesired (or unwanted) signals (hereinafter referred to as interference signals) received by existing wireless stations and beacons of wireless LAN APs, a monitoring time may be configured during which transmission of existing wireless stations is stopped for a certain period of time and beacons of unwanted wireless LAN APs in the vicinity are measured.

Here, the beacons of the wireless LAN AP may be interference signals, and the existing wireless station may determine that interference exists when the beacons are received.

As an example of the present disclosure, as illustrated in FIG. 4, a wireless LAN RF receiver (45) may be directly connected to a receiving antenna (30) of a fixed wireless station, and the wireless LAN RF receiver (45) may receive a wireless LAN RF signal and then input it into a wireless LAN beacon demodulator (50).

Here, the wireless LAN RF receiver (45) may measure the frequency range to which the automatic frequency adjustment system is applied.

Afterwards, the wireless LAN beacon demodulator (50) may obtain information on interference signals by demodulating the beacon of the wireless LAN AP (90) measured from the receiving antenna (30) and the wireless LAN RF receiver (45). That is, the wireless LAN beacon demodulator (50) may calculate the channel number, channel bandwidth, reception power, etc. of the wireless LAN used for each BSS ID of the wireless LAN AP.

Here, for more accurate reception power measurement, a beacon power measurement device (60) may be additionally installed (e.g., connected to a wireless LAN demodulator (50)). For example, the beacon power measurement device (60) may also correct the reception power using a more diverse digital signal processing method.

The beacon demodulation information transmitter (70) may transmit frequency sharing information, such as channel number and reception power, for each wireless LAN AP to the automatic frequency adjustment system (80) via wired or wireless communication.

Unlike a basic automatic frequency adjustment system, the automatic frequency adjustment system (80) of the present disclosure may store and manage BSS ID information of a wireless LAN AP that has been connected and registered in advance.

As an example of the present disclosure, it is assumed that the automatic frequency adjustment system (80) does not have BSS ID information of a pre-registered wireless LAN AP. In this case, the automatic frequency adjustment system (80) may have an authentication ID and serial number of the corresponding wireless LAN AP in order to identify the registered wireless LAN AP.

Accordingly, wireless LAN APs that connect to and register with the automatic frequency adjustment system (80) according to the present disclosure can transmit the BSS ID or MAC (Medium Access Control) address of the corresponding wireless LAN AP along with wireless LAN AP identification information (i.e., authentication ID or serial number information) when connecting to the automatic frequency adjustment system (80). The automatic frequency adjustment system (80) may distinguish wireless LAN APs by BSS ID or MAC address.

Accordingly, the automatic frequency adjustment system (80) may match the wireless LAN AP received from the beacon demodulation information transmitter (70) with the wireless LAN AP stored/managed in advance and provide new frequency joint use information to the corresponding wireless LAN AP.

Additionally or alternatively, the automatic frequency adjustment system (80) may distinguish wireless LAN APs by a method other than BSS ID (or MAC address).

For the basic method, the wireless LAN AP may transmit the authentication ID and serial number information of the wireless LAN AP to the automatic frequency adjustment system.

Wireless LAN APs that are registered by connecting to the automatic frequency adjustment system (80) of the present disclosure may transmit each wireless LAN AP authentication ID and serial number information to the automatic frequency adjustment system (80) by including each wireless LAN AP authentication ID and serial number information in a vendor specific element of a beacon that is determined in advance. The wireless LAN beacon demodulator (50) may demodulate each wireless LAN AP authentication ID and serial number information and then transmit this to the automatic frequency adjustment system (80) through the beacon information transmitter (70).

Accordingly, the automatic frequency adjustment system (80) according to the present disclosure may match a wireless LAN AP that is stored and managed in advance in the automatic frequency adjustment system (80) based on specific wireless LAN AP identification information received from a beacon demodulation information transmitter (70). In addition, the automatic frequency adjustment system (80) may provide new frequency sharing information to a specific wireless LAN AP.

Here, since the length of the Vendor Specific element of the beacon is up to 256 bytes, the size of the authentication ID and serial number information of the wireless LAN AP may be limited to 256 bytes or less.

An automatic frequency adjustment system (80) that has received information related to an interference signal may transmit i) new channel number information that does not overlap with the frequency of the measured interference signal and ii) maximum allowable channel power information to a wireless LAN AP (90) identified as the cause of interference among pre-registered wireless LAN APs.

Here, the maximum allowable channel power information may include information requesting that the beacon reception power be set to a specific value (e.g., ¼, 1/10, or a lower value of the system power) lower than the system noise power.

The maximum allowable channel power may be calculated based on the reception power of the beacon and the maximum allowable channel power of the wireless LAN AP (90) stored in advance in the automatic frequency adjustment system (80).

For example, if the wireless LAN beacon demodulator (50) has the transmitted channel power information of the corresponding wireless LAN AP through the TPC report element of the received beacon, the automatic frequency adjustment system (80) may directly calculate the propagation path loss value using the transmitted channel power information of the corresponding wireless LAN AP and the received power of the beacon.

And, the automatic frequency adjustment system (80) may determine the maximum allowable channel power of the corresponding wireless LAN AP so that the reception power of the beacon becomes ¼, 1/10 or less than the system noise power based on the calculated direct propagation path loss value.

Here, the beacon's reception power is measured based on a 20 MHz width, but the channel bandwidth of the wireless LAN AP varies greatly, such as 20, 40, 80, 160, and 320 MHz, so power compensation due to the difference in bandwidth may be required.

When newly updated channel number and maximum allowable channel power information are received from the automatic frequency adjustment system (80), the wireless LAN AP (90) identified as an interference signal source may readjust the channel number and frequency used by the wireless LAN AP (90) and the transmission channel power.

In FIG. 4, the wireless LAN AP (100) is a wireless LAN AP connected to an automatic frequency adjustment system (80), but refers to a transmitting device that is not detected and identified through a beacon of a wireless LAN beacon demodulator (50). In other words, the wireless LAN AP (100) may refer to a wireless device that is not a source of interference.

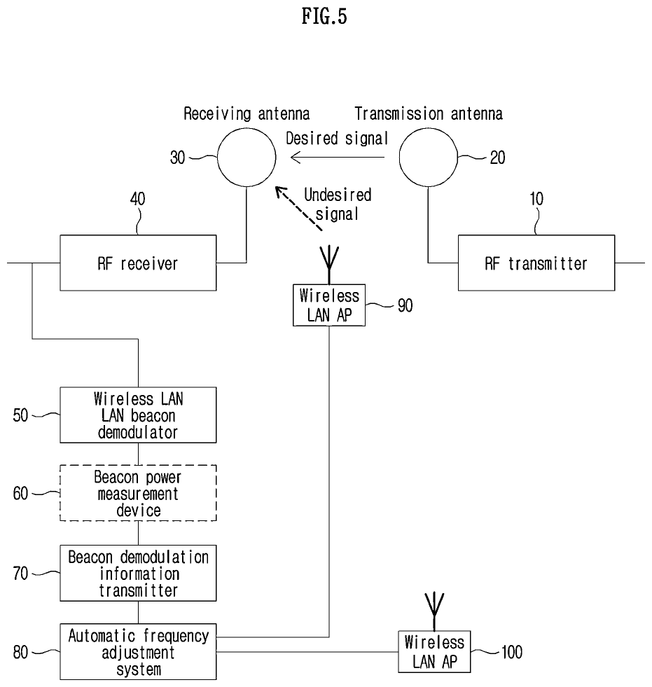

FIG. 5 is a drawing illustrating an alternative configuration and method for the automatic frequency adjustment system disclosed in FIG. 4.

Specifically, FIG. 5 is a configuration of a system without the wireless LAN RF receiver (45) illustrated in FIG. 4, and a signal passing through the RF receiver (40) of a fixed wireless station may be processed and utilized by a wireless LAN beacon demodulator (50). That is, the system according to FIG. 5 has the advantage that an automatic frequency adjustment operation may be performed without a wireless LAN RF receiver (45).

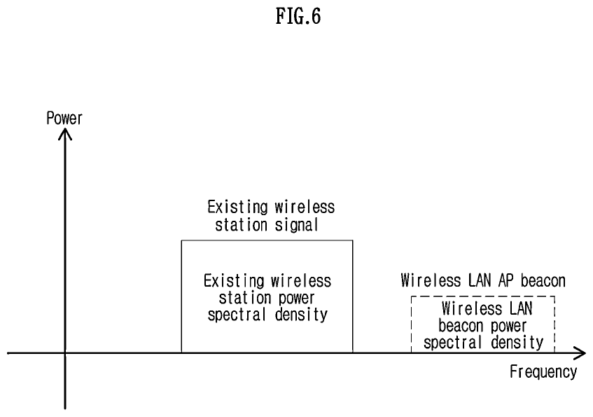

FIG. 6 is a diagram explaining the adjacent frequency usage environment of a wireless LAN AP in the case where an existing wireless station continues to transmit a desired signal.

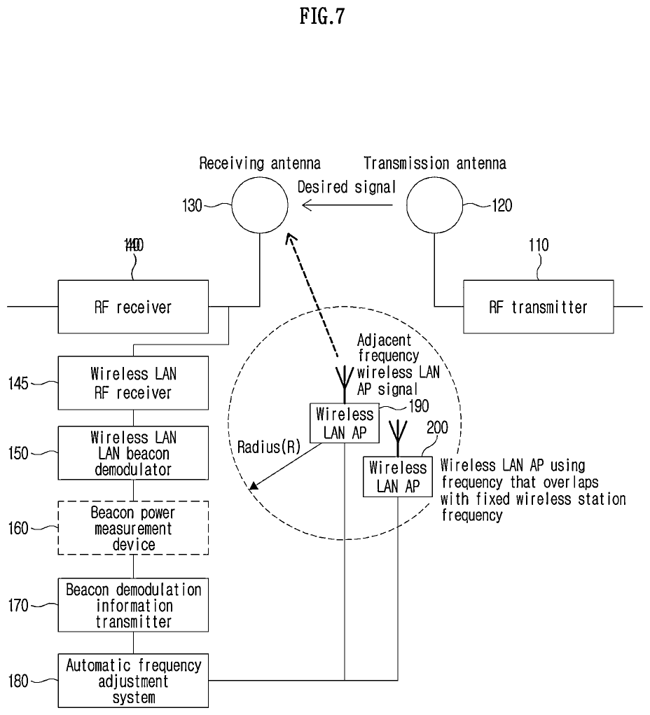

As illustrated in FIG. 6, a method for measuring a beacon of a surrounding wireless LAN AP in an adjacent frequency band not occupied by a desired signal while an existing wireless station continues to transmit a desired signal will be described with reference to FIG. 7.

Among existing wireless stations, the reception power of fixed microwave wireless stations is higher than that of wireless LAN APs, so it may be difficult to demodulate the beacon of a wireless LAN AP that overlaps with the reception frequency of the fixed microwave wireless station.

FIG. 6 illustrates a frequency usage situation in which the reception power spectral density of an existing wireless station signal and the reception power spectral density of a wireless LAN AP beacon do not overlap. As illustrated in FIG. 6, when the frequency of an existing wireless station signal and the frequency of a wireless LAN AP beacon are adjacent, the reception beacon of the wireless LAN AP may be demodulated.

Referring to FIG. 7, an existing wireless station may transmit a desired signal through an RF transmitter (110) and a transmitting antenna (120). A receiving antenna (130) and an RF receiver (140) may receive a desired signal transmitted through the RF transmitter (110) and the transmitting antenna (120).

Here, as an example of the present disclosure, the receiving antenna (130) of an existing wireless station may be connected to a wireless LAN RF receiver (145), and the wireless LAN RF receiver (145) may input a wireless LAN AP signal to a wireless LAN beacon demodulator (150).

Here, the wireless LAN RF receiver (145) may receive a frequency to which an automatic frequency adjustment system is applied. In addition, the wireless LAN RF receiver (145) may include a notch filter to suppress a high reception signal of a fixed wireless station using an adjacent frequency.

A wireless LAN beacon demodulator (150) may obtain signal information of wireless LAN APs by demodulating all beacons of adjacent frequencies that reach the receiving antenna (130).

That is, the wireless LAN beacon demodulator (150) may measure and then calculate the channel number, channel bandwidth, and reception power of all wireless LAN APs received as wireless LAN AP identification criteria in adjacent frequencies.

As described above, wireless LAN AP identification methods can be divided into the BSS ID method of the wireless LAN AP and the Vendor Specific element method that uses the authentication ID and serial number of the wireless LAN AP registered by connecting to the automatic frequency adjustment system.

Additionally, for more accurate reception power measurement, the beacon power measurement device (160) may correct the already measured reception power through various signal processing.

A beacon demodulation information transmitter (170) may transmit frequency sharing information, such as channel number and reception power, to an automatic frequency adjustment system (180) via wired or wireless communication as identification criteria for a wireless LAN AP using an adjacent frequency.

An automatic frequency adjustment system (180) that receives information on wireless LAN APs using adjacent frequencies may select a wireless LAN AP (200) whose frequency overlaps with an existing wireless station, centering on a wireless LAN AP (190) identified as using an adjacent frequency among wireless LAN APs connected in advance. For example, the automatic frequency adjustment system (180) may select a wireless LAN AP (200) whose frequency overlaps with an existing wireless station, targeting all wireless LAN APs within a specific radius (R) centering on a wireless LAN AP (190).

Thereafter, the automatic frequency adjustment system (180) may transmit information on the maximum allowable channel power to the selected wireless LAN AP (200) so that the received power of the wireless LAN AP (190) is ¼, 1/10 or more lower than the system noise power, or transmit information on the suspension of operation of the corresponding wireless LAN channel frequency.

Here, the maximum allowable channel power may be calculated using the reception power of the beacon and the maximum allowable channel power of the wireless LAN AP (190) stored in advance in the automatic frequency adjustment system (80).

For example, if the wireless LAN beacon demodulator (150) has transmission power information of the corresponding wireless LAN AP through the TPC Report element of the received beacon, the automatic frequency adjustment system (80) may directly calculate the propagation path loss value using the transmission power information of the corresponding wireless LAN AP and the reception power of the beacon.

And, the automatic frequency adjustment system (80) may determine the maximum allowable channel power of the wireless LAN AP so that the reception power of the beacon is ¼, 1/10 or less than the system noise power based on the direct propagation path loss value.

Here, as described above, the reception power of the beacon is measured only in a 20 MHz width, and the channel bandwidth of the wireless LAN AP to be used is very diverse, such as 20, 40, 80, 160, and 320 MHz, so power compensation due to the difference in bandwidth may be required.

In the case of the present disclosure that utilizes beacon information of a wireless LAN AP received on an adjacent frequency, it is assumed that a wireless LAN AP (200) beacon that overlaps with an existing wireless station frequency and a wireless LAN AP (190) beacon that uses an adjacent frequency have the same propagation path loss within a radius (R), and therefore, the size of the radius (R) of FIG. 7 can be determined based on the propagation path loss.

Additionally or alternatively, the wireless LAN beacon demodulator (150) may obtain beacon transmission channel power information of a surrounding AP from the TPC Report element of the transmitted beacon. Accordingly, since propagation path loss data can be directly obtained by measuring the beacon reception power, a new propagation path loss model may be generated based on the propagation path loss data.

A new propagation path loss model may be applied to the automatic frequency adjustment system (80, 180) of the present disclosure, and the propagation path loss model may be utilized to calculate the maximum allowable channel power of a wireless LAN AP more accurately.

So far, the present disclosure has described a case where frequency sharing information updates of wireless LAN APs are performed on a channel-by-channel basis (i.e., a channel-by-channel criterion is applied).

When the frequency common use information update of a wireless LAN AP is based on a MHz-by-MHz basis, the automatic frequency adjustment system (80, 180) of the present disclosure may convert and calculate the maximum allowable power per MHz based on the channel number and maximum allowable channel power received from the beacon demodulation information transmitter (70, 170).

The automatic frequency adjustment system (80, 180) of the present disclosure can transmit the calculated maximum allowable power per MHz to the corresponding wireless LAN AP connected to the system.

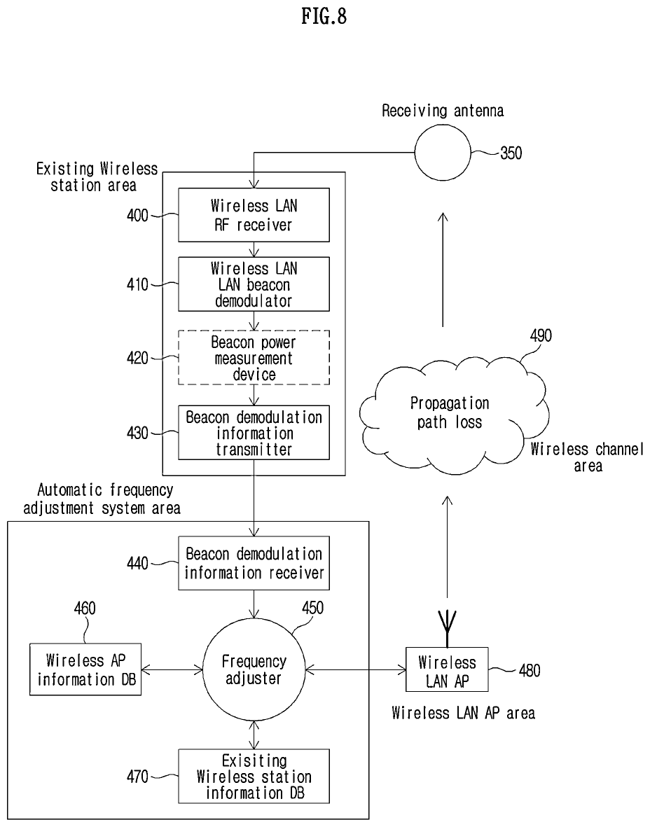

FIG. 8 illustrates an existing wireless station area, an automatic frequency adjustment system area, a wireless LAN AP area, a wireless channel area, etc. to which a method and device using a beacon of a wireless LAN AP according to one embodiment of the present disclosure are applied.

As an example of the present disclosure, the existing wireless station area may include a wireless LAN RF receiver (400), a wireless LAN beacon demodulator (410), a beacon power measurement device (420), a beacon demodulation information transmitter (430), etc., connected to a receiving antenna (350) of the existing wireless station.

The automatic frequency adjustment system area may include a beacon demodulation information receiver (440), a frequency adjuster (450), a wireless LAN AP information DB (460), an existing wireless station information DB (470), etc.

The wireless LAN AP area may use the Vendor Specific element to identify the wireless LAN AP through the beacon of the wireless LAN AP (480). The wireless LAN AP area may use the TPC element that has the transmission power information of the wireless LAN AP.

The propagation channel area may calculate the propagation path loss value by using the beacon transmission power and beacon reception power of individual wireless LAN APs.

That is, the present disclosure illustrates a method and device for protecting an existing wireless station from a wireless LAN AP based on a configuration such as that of FIG. 8.

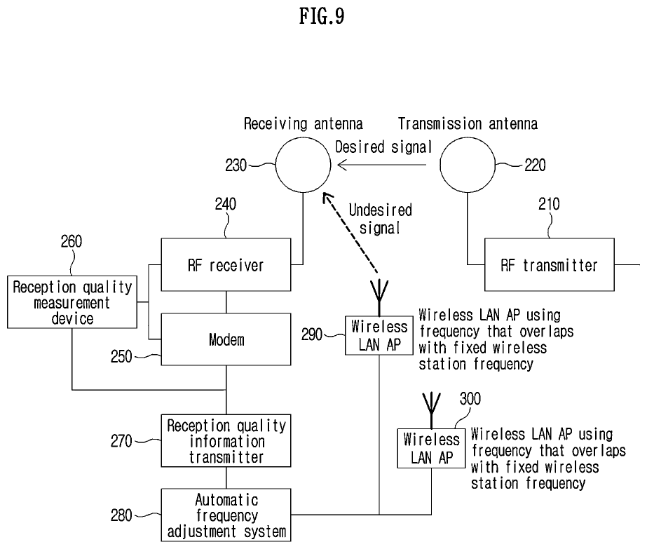

FIG. 9 is a drawing for explaining a device and method using a reception quality measurement device of an existing wireless station according to one embodiment of the present disclosure.

Specifically, FIG. 9 relates to a method for determining whether a wireless LAN AP using the same frequency as an existing wireless station transmits around an existing wireless station by using distance information between the existing wireless station and the wireless LAN AP, when the existing wireless station includes a reception quality measurement device.

An RF transmitter (210) that receives transmission data from an existing wireless station can transmit a desired signal through a transmission antenna (220). An RF signal received from a reception antenna (230) of an existing wireless station may be input to a modem (250) through an RF receiver (240) and demodulated.

Here, the reception quality measurement device (260) may monitor the reception status by measuring pre-determined quality criteria, such as signal-to-noise ratio and bit error rate.

When radio interference or performance degradation occurs in an existing wireless station due to a wireless LAN AP signal, the reception quality measurement device may measure information on changes in reception quality, such as a decrease in signal-to-noise ratio and an increase in bit error rate.

Here, the reception quality information transmitter (270) may transmit information obtained from the reception quality measurement device (260) to the automatic frequency adjustment system (280).

If the reception quality does not satisfy a pre-determined standard, the automatic frequency adjustment system (280) that has acquired the reception quality information can transmit information to the wireless LAN AP (290, 300) to stop the transmission operation of the wireless LAN AP that is overlapping with the reception frequency of the existing wireless station.

Accordingly, the wireless LAN AP may stop transmitting radio waves using the same frequency as the existing wireless station and the channel number of the wireless LAN AP that overlaps. If it is detected that the reception quality of the existing wireless station continues to deteriorate even after the transmission of the wireless LAN AP close to the existing wireless station is stopped, the wireless LAN AP may perform a transmission operation.

The method of stopping the transmission operation of the wireless LAN AP described above may be applied to an automatic frequency adjustment system (280) that knows the location of the receiving antenna of an existing wireless station and the location of the wireless LAN AP in advance.

For example, a method for stopping the transmission operation of wireless LAN APs connected to the same system in the order of the closest distance in a straight line to an existing wireless station that does not satisfy the reception quality due to interference signals and a method for stopping the transmission operation of wireless LAN APs by a certain distance unit between the existing wireless station and the wireless LAN AP, i.e., by a straight line distance group such as 1,000 meters, 1,500 meters, etc. may be applied.

The automatic frequency adjustment system (280) may selectively use one of the two methods described above. Here, the straight-line distance mentioned above can mean a distance in a three-dimensional space in which the ground height (or sea level height) of the receiving antenna of the existing wireless station and the ground height (or sea level height) of the wireless LAN AP are taken into consideration.

In the basic method, frequencies may be shared between existing wireless stations and wireless LAN APs through frequency sharing information provided by an automatic frequency coordination system that uses geo-location information such as the location of wireless stations.

At this time, it was not monitored whether the signal used by the wireless LAN AP based on the information obtained from the automatic frequency adjustment system caused interference to existing wireless stations in the vicinity.

According to various embodiments of the present disclosure, whether interference occurs with respect to a channel number and channel transmission power of a wireless LAN AP may be monitored through a sensing-based beacon monitoring method and device comprising a wireless LAN RF receiver, a wireless LAN beacon demodulator, a beacon demodulation information transmitter, and the like.

Afterwards, if interference of a wireless LAN AP is detected using frequency common use information acquired from wireless LAN beacon monitoring, the channel number and channel transmission power of the wireless LAN AP may be adjusted to avoid interference, or the transmission and reception operations of the wireless LAN AP may be stopped.

Additionally, by various embodiments of the present disclosure, it is possible to obtain domestic terrain-based propagation path loss data by directly measuring the transmission power and reception power of the beacon for each wireless LAN AP, thereby achieving a technical effect of utilizing this to develop a new propagation path loss model suitable for domestic terrain.

In addition, according to various embodiments of the present disclosure, when an existing wireless station receives interference from a surrounding wireless LAN AP, a method and device may be provided that can protect the existing wireless station by stopping the transmission operation of a wireless LAN AP located close to the existing wireless station based on the reception quality deterioration information acquired through the reception quality measurement device of the existing wireless station.

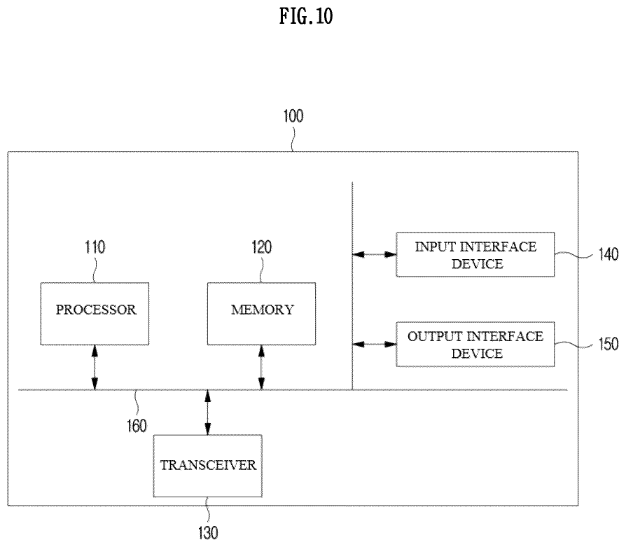

FIG. 10 is a block diagram illustrating one or more devices constituting an automatic frequency adjustment system according to an embodiment of the present disclosure.

That is, FIG. 10 is a block diagram briefly illustrating one or more devices that automatically monitor frequency by configuring an automatic frequency adjustment system.

For example, the device (100) may determine a new channel and maximum allowable power to be used by the first wireless LAN AP based on information related to the first beacon frame received from the wireless station via the transceiver (130).

The device (100) may include at least one of a processor (110), a memory (120), a transceiver (130), an input interface device (140), and an output interface device (150). Each of the components may be connected to each other by a common bus (160). In addition, each of the components may be connected to each other through an individual interface or: individual bus centered on the processor (110), rather than the common bus (160).

The processor (110) may be implemented in various types such as an AP (Application Processor), a CPU (Central Processing Unit), a GPU (Graphic Processing Unit), etc., and may be any semiconductor device that executes a command stored in the memory (120). The processor (110) may execute a program command stored in the memory (120). The processor (110) may obtain an image of a specific river based on the above-described FIGS. 1 to 9.

The processor (110) may include one or more modules for automatically monitoring frequency.

And/or, the processor (110) may store program instructions for implementing at least one function for one or more modules in the memory (120) to control the operations described based on FIGS. 1 to 9 to be performed. That is, each operation and/or function according to FIGS. 1 to 9 may be executed by one or more processors (110).

The memory (120) may include various forms of volatile or non-volatile storage media. For example, the memory (120) may include read-only memory (ROM) and random access memory (RAM). In an embodiment of the present disclosure, the memory (120) may be located inside or outside the processor (110), and the memory (120) may be connected to the processor (110) through various means already known.

For example, the memory (120) may store a database including identification information of multiple wireless LAN APs.

The transceiver (130) may perform a function of transmitting and receiving data processed/to be processed by the processor (110) with an external device and/or an external system.

For example, the transceiver (130) may be utilized for data exchange with other terminal devices, etc.

The input interface device (140) may be configured to provide data to the processor (110).

The output interface device (150) may be configured to output data from the processor (110).

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e. g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A wireless system comprising:
a wireless station including a beacon demodulator; and
an automatic frequency adjustment system having a database including identification information of a plurality of wireless local area network (LAN) access points (Aps),
wherein the wireless station is configured to:
obtain information related to a first beacon frame by demodulating the first beacon frame transmitted from a first wireless LAN AP through the beacon demodulator; and
transmit the information related to the first beacon frame to the automatic frequency adjustment system, and
wherein the automatic frequency adjustment system is configured to:
identify a first wireless LAN AP that matches the information related to the first beacon frame among the plurality of wireless LAN APs through the database; and
transmit a new channel and maximum allowable power to be used by the first wireless LAN AP to the first wireless LAN AP based on the information related to the first beacon frame.

2. The method of claim 1, wherein:
the information related to the first beacon frame includes a number of a wireless LAN channel through which the first beacon frame was transmitted, a bandwidth of the wireless LAN channel, a reception power of the first beacon frame, and identification information of the first wireless LAN AP that transmitted the first beacon frame.

3. The method of claim 2, wherein:
the identification information of the first wireless LAN AP includes at least one of an authentication ID, a serial number, a basic service set (BSS) ID, or a medium access control (MAC) address of the first wireless LAN AP.

4. The method of claim 2, wherein:
the wireless station includes at least one of a beacon power measurement device or a reception quality measurement device,
a power of a target signal received from a transmitting device is measured by the reception quality measurement device, and
the reception power of the first beacon frame, which is an interference signal of the target signal, is measured by the beacon power measurement device.

5. The method of claim 4, wherein:
a first frequency band in which the first beacon frame is transmitted is adjacent to a second frequency band in which the target signal is transmitted, and
the automatic frequency adjustment system is configured to:
identify at least one wireless LAN AP within a predefined distance from the first wireless LAN AP that transmitted the first beacon frame based on the database, and
identify a second wireless LAN AP that transmits a second beacon frame in the second frequency band among the at least one wireless LAN AP.

6. The method of claim 5, wherein:
the automatic frequency adjustment system is configured to:
transmit, to the second wireless LAN AP, at least one of a first message including a new channel and maximum allowable power to be used by the second wireless LAN AP or a second message indicating a stop of use of the second frequency band.

7. The method of claim 2, wherein:
the beacon demodulator identifies a reception power of the first beacon frame through a transmitter power control (TPC) report element included in the first beacon frame, and
the automatic frequency adjustment system sets a maximum allowable power of the first beacon frame to a value equal to a predefined ratio of a noise power of the wireless system.

8. The method of claim 4, wherein:
the reception quality measurement device monitors a reception quality of the target signal based on at least one of a signal-to-noise ratio (SNR) or bit error rate (BER) of the target signal.

9. The method of claim 8, wherein:
the automatic frequency adjustment system is configured to:
receive information on the reception quality of the target signal from the wireless station, and
based on the reception quality of the target signal not satisfying a specific criterion, transmit a third message to the first wireless LAN AP requesting to stop transmitting the first beacon frame.

10. A method for controlling a wireless system including a wireless station and an automatic frequency adjustment system, the method comprising:
obtaining information related to a first beacon frame by demodulating a first beacon frame transmitted from a first wireless LAN AP by the wireless station;
transmitting the information related to the first beacon frame by the wireless station to the automatic frequency adjustment system;
identifying the first wireless LAN AP that matches the information related to the first beacon frame among a plurality of wireless LAN APs through a database including identification information of the plurality of wireless LAN APs by the automatic frequency adjustment system; and
transmitting, to the first wireless LAN AP, a new channel and maximum allowable power to be used by the first wireless LAN AP based on the information related to the first beacon frame by the automatic frequency adjustment system.

11. The method of claim 10, wherein:
the information related to the first beacon frame includes a number of a wireless LAN channel through which the first beacon frame was transmitted, a bandwidth of the wireless LAN channel, a reception power of the first beacon frame, and identification information of the first wireless LAN AP that transmitted the first beacon frame.

12. The method of claim 11, wherein:
the identification information of the first wireless LAN AP includes at least one of an authentication ID, a serial number, a basic service set (BSS) ID, or a medium access control (MAC) address of the first wireless LAN AP.

13. The method of claim 11, wherein:
the wireless station includes at least one of a beacon power measurement device or a reception quality measurement device,
a power of a target signal received from a transmitting device is measured by the reception quality measurement device, and
the reception power of the first beacon frame, which is an interference signal of the target signal, is measured by the beacon power measurement device.

14. The method of claim 13, wherein:
a first frequency band in which the first beacon frame is transmitted is adjacent to a second frequency band in which the target signal is transmitted, and
the method further comprises:
identifying at least one wireless LAN AP within a predefined distance from the first wireless LAN AP that transmitted the first beacon frame based on the database, and
identifying a second wireless LAN AP that transmits a second beacon frame in the second frequency band among the at least one wireless LAN AP.

15. The method of claim 14, further comprising:
transmitting, by the automatic frequency adjustment system, to the second wireless LAN AP at least one of a first message including a new channel and maximum allowable power to be used by the second wireless LAN AP or a second message indicating a stop of use of the second frequency band.

16. The method of claim 11, wherein:
the obtaining information related to the first beacon frame includes:
by the wireless station, identifying a reception power of the first beacon frame through a transmitter power control (TPC) report element included in the first beacon frame, and
the transmitting a maximum allowable power to be used by the first wireless LAN AP includes:
setting a maximum allowable power of the first beacon frame to a value equal to a predefined ratio of a noise power of the wireless system.

17. The method of claim 13, wherein:
the reception quality measurement device monitors a reception quality of the target signal based on at least one of a signal-to-noise ratio (SNR) or bit error rate (BER) of the target signal.

18. The method of claim 17, further comprising:
by the automatic frequency adjustment system, receiving information on the reception quality of the target signal from the wireless station, and
by the automatic frequency adjustment system, based on the reception quality of the target signal not satisfying a specific criterion, transmitting a third message to the first wireless LAN AP requesting to stop transmitting the first beacon frame.

19. An automatic frequency adjustment system comprising:
at least one memory;
at least one transceiver; and
at least one processor,
wherein the at least one processor is configured to:
receive, from a wireless station through the at least one transceiver, information related to a first beacon frame transmitted from a first wireless LAN AP;
identify the first wireless LAN AP matching the information related to the first beacon frame among a plurality of wireless LAN APs through a database including identification information of the plurality of wireless LAN Aps; and
transmit, to the first wireless LAN AP through the at least one transceiver, a new channel and maximum allowable power to be used by the first wireless LAN AP based on the information related to the first beacon frame.
